(19) United States
(12) Patent Application Publication
(10) Pub. No.: US 2004/0242260 A1
(43) Pub. Date: Dec. 2, 2004

(54) Method for controlling radio resources allocated to a mobile terminal in a cellular system

(76) Inventor: Pierre Lescuyer, Montigny Le Bretonneux (FR)

Correspondence Address: PIPER RUDNICK, P. O. BOX 64807, CHICAGO, IL, 60664-0807, US

(21) Appl. No.: 10/493,997

(22) PCT Filed: Oct. 17, 2002
(86) PCT No.: PCT/FR02/03556

(30) Foreign Application Priority Data
Oct. 29, 2001 (FR) 01/13964

(51) Int. Cl. H04B 7/00

(52) U.S. Cl. 455/525

(57) ABSTRACT

The invention relates to a method of controlling radio resources allocated to a mobile terminal in a cellular system. According to the invention, radio measurements relating to propagation conditions between the terminal and a group of base stations in the cellular system are obtained. The aforementioned measurements are analysed and used to select at least one base station and establish a radio link between said station and the terminal in order to carry out the communication. The cellular system comprises a first and a second group of base stations which are used to communicate respectively using a first and a second network. The two aforementioned groups comprise a common sub-group of shared base stations. When the communicating terminal has an active radio link with a shared base station of said sub-group, a radio network controller stores information identifying a home network of said terminal and another base station, which does not belong to said sub-group, is selected, dependent on the stored information.

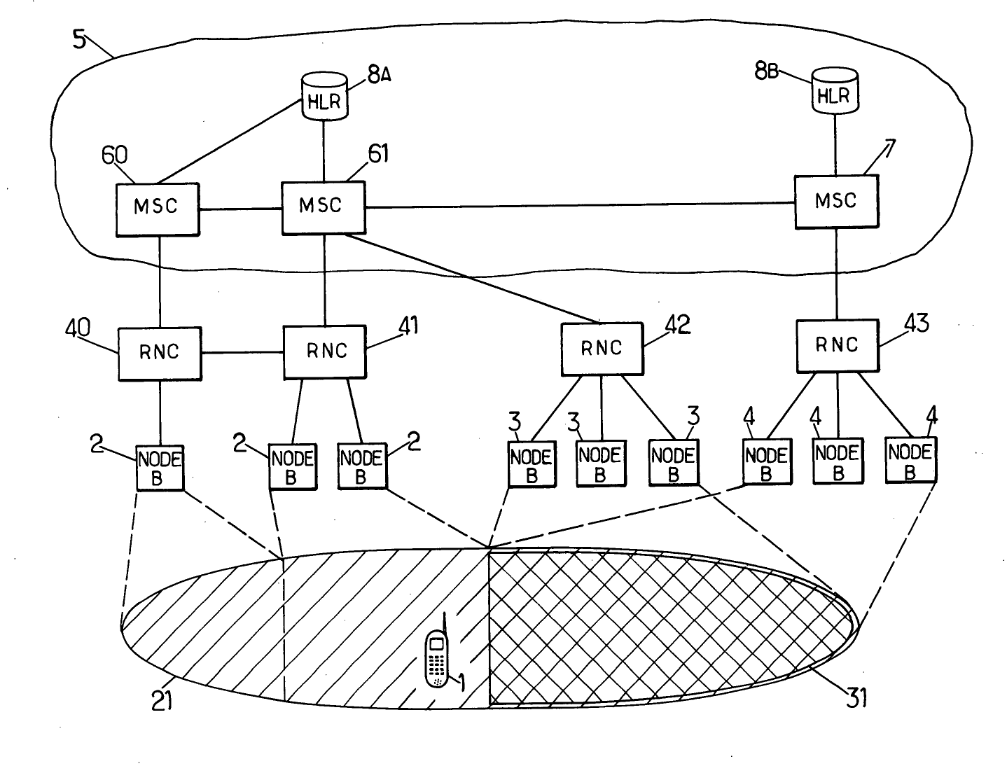

The present invention relates to the control of the radio resources allocated to a mobile terminal in communication in a cellular system, and more especially the procedures for transferring links between cells.

This type of transfer is commonly called intercellular “handover”. “Hard handover”, or HHO, which proceeds by instantaneous cutover of the base-station communication from a first to that of a second cell, is to be distinguished from “soft handover”, or SHO, that is supported by some systems and in which there is a phase of a certain duration where the mobile communicates simultaneously with the base stations.

The second generation cellular system GSM (Global System for Mobile communications) uses a multiple access technique distributed over time, known as TDMA (Time-Division Multiple Access), and only supports HHO. On the other hand, the third generation system UMTS (Universal Mobile Telecommunication System) employs a multiple access technique distributed over wideband codes, known as W-CDMA (Wideband Code-Division Multiple Access), allowing it to support both HHO and SHO.

The handover procedures are carried out, usually automatically, in the cellular systems in a manner which ensures that the mobile in connected mode, in other words having an ongoing communication, has a quality of radio link that is sufficiently good to allow the communication to continue under favorable conditions. There are also other handover criteria, which are based on considerations not directly associated with the propagation conditions, such as the distribution of traffic as a function of the type of cells, for example.

A handover procedure comprises a measurement step, in which a mobile station and at least one base station periodically perform radio measurements, downlink (measurements at the receiver of the mobile) or uplink (measurements at the receiver of one or more base stations on signals coming from the mobile), relating to propagation conditions. If a communication channel is established between the mobile station and a base station, the measurements can be carried out over this channel. These measurements reflect, in particular, the strength of the uplink and downlink signal over the radio channel, but they can also take into account an indicator of the quality of the radio link as well as an indicator of the distance separating the mobile station and base station. Additionally, the mobile station periodically carries out measurements on the strongest signals that it receives from a certain number of neighboring cells. In the other direction, the base stations of these neighboring cells can also perform measurements on the uplink signal.

These measurements are periodically transmitted to the system entity that manages the handover procedure. This entity processes the measurements by averaging them and, using mathematical algorithms, by assessing whether or not they meet one or more predetermined handover criteria.

In the framework of the present invention, this system entity managing the handover procedure is a base-station controller (BSC) or radio network controller (RNC). This architecture is notably that of the aforementioned GSM and UMTS systems.

The list of neighboring cells to be taken into consideration is determined by the controller, and the receivers concerned are instructed accordingly. For the downlink measurements, the references of the cells concerned (frequency, spreading codes, . . . ) are broadcast over a common control channel and/or sent to the mobile terminal over a dedicated resource. For the uplink measurements, the controller activates the measurements at the base-station receivers.

If a handover criterion is met, a transfer is then decided by the controller which is responsible for determining, depending on the previous criterion, which cell—known as the target cell—is the most appropriate to receive the mobile station and the ongoing communication (or, in the case of SHO, which one will be added to the active set of base stations having a communication channel with the terminal). As was seen above, the radio network controller also has available other information which can be used in its algorithms notably for the choice of target cell. The instantaneous load of a candidate neighboring cell, for example, can thus form part of the elements to be taken into account in the final choice of the target cell, in addition to criteria associated with the estimated quality of the new radio link.

Finally, in the case of the HHO, the cutover is carried out. For the SHO, the new cell is added to the active set and the current cell can be later removed from the active set.

Another problematic area addressed by the invention relates to the heterogeneous coexistence of two or more radiocommunications networks, or PLMN (Public Land Mobile Networks), within a geographic area. Indeed, it can happen, for example, that a first PLMN, run by an operator A, possesses a group of base stations having a radio coverage that allows a mobile terminal to communicate over a geographic area A′ and that a second PLMN, run by an operator B, possesses another group of base stations having a radio coverage that allows a mobile terminal to communicate over a second geographic area B′ which overlaps the area A′. In some cases, these operators may agree that one of them, for example A, will make available to the subscribers of the other (B) a part of his access infrastructure serving the area C′ not covered by B. This area C′ is known as a “shared coverage area”.

The above allows the subscribers of B to take advantage of a more extended coverage than area B′. In exchange, a royalty is normally paid by B to A. However, in the area B′, the operator B would generally like the communications of its subscribers to use its own infrastructure, in order to make this profitable and to avoid the repayments to A.

It should be noted that this problem can arise independently of the ownership of the infrastructures, for example in the context of a virtual operator managing subscribers without owning an access network. In such a case, the “network” or PLMN of this virtual operator can be seen as consisting of its subscriber management infrastructure or HLR (Home Location Register) associated with the switching and radio access resources borrowed from another operator.

In the case of mobiles in idle mode, in other words having no session in progress with the access network, the PLMN identities are taken into account by the mobiles in the process of cell selection and reselection, such that the switching is effected in a natural fashion (see technical specifications 3GPP TS 25.304 “UE Procedures in Idle Mode and Procedures for Cell Reselection in Connected Mode”, version 3.8.0 Release 1999, published in September 2001 by the 3GPP organization and 3GPP TS 23.122 “Non-Access-Stratum functions related to Mobile Station (MS) in idle mode”, version 4.1.0 Release 4, published in June 2001 by the 3GPP organization).

The U.S. Pat. No. 5,561,845 takes advantage of this feature of the idle mode and proposes a method, for a mobile subscriber, for favoring the use of his home network when he wishes to establish a communication. For this purpose, a device known as a “border protector”, which does not offer the dedicated communication resources of a base station, repeats control signals transmitted by two PLMNs within an intermediate area corresponding to the overlap between two areas respectively served by the two PLMNs. These retransmitted control signals are designed to be the strongest signals in the intermediate area. The mobiles in idle mode in the intermediate area select the channels broadcast in this area and are redirected toward their home PLMN by the border protector during a call establishment request, on the basis of a mobile identifier.

Currently, nothing is provided as regards active mobiles. For example, a B subscriber terminal, in communication with a base station in the shared coverage area C′ and heading toward the area B′, currently has no means of having the communication transferred in a preferential or systematic manner to an operator B base station, especially since it is not the mobile that controls the handover procedures.

An object of the present invention is to respond to this need.

The invention thus proposes a method for controlling radio resources allocated to a mobile terminal in communication in a cellular system, in which radio measurements relating to propagation conditions between the terminal and a group of base stations of the cellular system are obtained. Said measurements are analyzed so as to select at least one base station and to establish a radio link between the terminal and the selected base station in order to ensure continuity of the communication. The cellular system comprises a first group of base stations procuring radio access resources for terminals of subscribers to a first network and a second group of base stations procuring radio access resources for terminals of subscribers to a second network, the first and second groups having a common sub-group of shared base stations. When the terminal in communication has an active radio link with a shared base station of said sub-group, a radio network controller of the cellular system stores information identifying a home network of said terminal and the selection of another base station not belonging to said sub-group is made in a manner that depends on the stored information identifying the terminal home network.

Since each mobile has a home PLMN, the identification of the latter is taken into account during the handover procedure executed by the controller responsible for the shared coverage area. This gives a wide flexibility to the operators in defining the way to orient the handovers of their respective subscribers outside of the shared coverage area. The same flexibility is offered for the subscribers of the other operators who are “roaming”.

The information identifying the home network of the terminal may be deduced by the system from the identity of the mobile subscriber using the terminal, which avoids the system having to manage an additional parameter.

The invention also proposes a radio network controller adapted to the implementation of the above method.

Further features and advantages of the present invention will become apparent in the following description of non-limiting examples of embodiments, which refers to the appended drawing, in which:

the single FIGURE is a schematic diagram of an embodiment of the invention in a UMTS (Universal Mobile Telecommunications System) radiocommunications network, in circuit transmission mode.

The invention is described hereafter in its application to a UMTS network for a voice transmission in circuit mode. This application is illustrated in the single FIGURE.

The single FIGURE shows a UMTS network core network 5 comprising at least one MSC switch (Mobile services Switching Centre) and at least one subscriber management system HLR (Home Location Register). These installations are exploited by at least one operator. In general, each HLR deployed in this core network corresponds to a PLMN and to a group of subscribers to the operator of this PLMN. Accordingly, in the example shown, the operator of the PLMN A manages the HLR 8A, whereas the operator of the PLMN B manages the HLR 8B.

To the core network are linked radio access network subsystems (RNS Radio Network Subsystem) comprising at least one RNC (Radio Network Controller) 40-43 which manages a group of “Node-B” base stations 2-4 each comprising at least one transceiver. In order to simplify the description, the following case will be considered: the base stations 2-3 controlled by the RNCs 40 to 42 define the coverage area 21 of the PLMN A, whereas the base stations controlled by the RNC 43 define the coverage area of the PLMN B, the base stations controlled by the RNC 43 having, in this example, approximately the same coverage area 31 as those controlled by the RNC 42. This area 31 is called a “strategic coverage area”, whereas the area covered by the base stations controlled by the RNCs 40 and 41 is the “shared coverage area”.

Upon establishment of the communication between a terminal 1 and a base station 2 of the shared coverage area, a procedure called COMMON ID is carried out. This procedure is described in the technical specification 3GPP TS 25.413 (“UTRAN Iu Interface RANAP Signalling”, version 4.1.0 Release 4, published in June 2001 by the 3GPP organization). For the core network 5 upon which the communication depends, it consists in supplying the IMSI (International Mobile Subscriber Identity) of the terminal 1 to the RNC 41 that is currently controlling this terminal. Its primary aim is to enable the RNC to make a link between the RRC (Radio Resource Control) protocol connection that it has with the terminal 1 and the identity of this terminal, so as to be able to transmit a request to this terminal 1, if required, via the RRC connection already established, rather than by broadcasting over the common radio resources.

A unique IMSI parameter is actually attributed to each mobile subscriber and stored in the HLR of their home network. The 3GPP standard 23.003 (“Numbering, Addressing and Identification”, version 4.1.0 Release 4, published in June 2001 by the 3GPP organization) details the structure of this parameter which is composed of 15 bits. Starting with the most significant bits:

The first three bits form the MCC (Mobile Country Code) parameter. The MCC uniquely identifies the home network country of the mobile subscriber;

The following two or three bits form the MNC (Mobile Network Code), whose length depends on the MCC. The MNC indicates the home network of the mobile subscriber.

The final bits form the MSIN (Mobile Subscriber Identification Number). This field identifies the mobile subscriber within a network.

The RNC which has this information available is thus able to deduce, in a unique and definitive way from the first MCC and MNC fields of the IMSI, the home network of the mobile subscriber associated with the terminal 1.

In a first embodiment of the invention, the RNC makes use of this information from the IMSI to filter out the neighboring cells whose frequencies and scrambling codes it communicates to the terminal over a communication channel of the base station supporting the communication underway.

Accordingly, if the terminal 1 having as home network the PLMN A (in other words, that which has its subscribers listed in the HLR 8A) is in communication with a base station 2 under the responsibility of the RNC 41 and if the neighboring cells of the PLMNs A and B have already been defined for this base station, the RNC 41 can indicate to the terminal to carry out signal strength measurements only on the neighboring cells of the PLMN A. In the case of the downlink measurements, this mode of operation is made possible thanks to the communication, in the “Measurement Control” message from the RNC 41 to the terminal 1 over a DCCH (Dedicated Control Channel), of the list of frequencies and scrambling codes on which the terminal must make its measurements, as is described in sections 8.4.1 and 10.2.17 of the technical specification 3GPP TS 25.331, “RRC Protocol Specification”, version 4.1.0 Release 4, published in June 2001 by the 3GPP organization. In this case, the terminal 1 will only report its measurements to the RNC 41, via the current base station 2, for the corresponding cells. This is implemented by way of the “Measurement Report” message (sections 8.4.2 and 10.2.19 of the aforementioned specification 3GPP TS 25.331) sent by the terminal to the RNC 41 over a DCCH uplink channel and containing the results of the measurements performed by the terminal for each scrambling code indicated in the “Measurement control” message.

In an equivalent manner, the uplink measurements can only be carried out and reported by the base stations managing the cells neighboring the PLMN A at the request of the RNC. This case follows the procedures described in the technical specification 3GPP TS 25.433 “UTRAN Iub Interface NBAP Signalling”, version 4.2.0 Release 4, published by the 3GPP organization in September 2001 (sections 8.3.8 to 8.3.11 and 9.1.52 to 9.1.57).

After analyzing the reports of the measurements received, the RNC will activate a radio link with the terminal only for a cell of the PLMN A and not for a cell of the PLMN B for which no measurements are available owing to the initial filtering based on the PLMN identity. The creation of this radio link can be effected through SHO, updating the mobile on its active set (section 8.3.4 of the aforementioned specification 3GPP TS 25.331) and activating the resource of the base station 3 concerned (section 8.3.17 of the aforementioned specification 3GPP TS 25.433), or through HHO (sections 8.3.5 and 8.2.17, respectively, of the specifications 3GPP TS 25.331 and 3GPP TS 25.433).

In the case where the handover involves the core network 5, particularly in the case of a change of MSC, use is made, in a manner known per se, of the procedures described in the technical specification 3GPP TS 23.009, “Handover procedures”, version 4.1.0 Release 4, published in June 2001 by the 3GPP organization.

If the terminal 1, in communication within the shared coverage area, belongs to the PLMN B, the same initial cell filtering process allows the cells of the PLMN A covering the strategic coverage area 31, in other words those controlled by the RNC 42, to be eliminated. The handover from the shared coverage area to the strategic coverage area will generally be an HHO.

In this way, it is ensured that the infrastructure of a given PLMN is utilized for the communications of its subscribers in the strategic coverage area.

For handovers from the strategic coverage area to the shared coverage area, it suffices to indicate the cells 2 of the shared coverage area among the neighbors of the cells 3-4 of the strategic coverage area 31 without the need to distinguish between the two PLMNs.

A second embodiment consists in the RNC 41 supplying to the terminal 1, in communication with a base station 2 of the shared coverage area, the scrambling codes corresponding to the neighboring cells already declared for the base station, independently of whether the latter are associated with base stations of the PLMN A or of the PLMN B. In this case, the terminal performs measurements on the codes of all of the neighboring cells and reports its measurements to the RNC, according to the same procedure as that previously described. In the case where the terminal 1 is moving toward the strategic coverage area 31 and where at least one handover criterion is met, according to a non-normalized algorithm specific to the RNC, the RNC sorts the candidate neighboring cells with respect to establishing a communication link with the terminal and ensuring the continuity of the communication. At this stage, it can take into account the PLMN identity deduced from the terminal IMSI, which is first acquired during the COMMON ID procedure, comparing it to the PLMNs on which the thus sorted neighboring cells depend.

Different strategies can then be applied in order to orient the handover toward the strategic coverage area 31.

For example, with respect to the subscribers of the PLMN A, the operator could favor the base stations 3 which depend on its RNC 42 and could have recourse to those 4 dependant on the RNC 43 of the PLMN B only in the case of a more serious risk of loss of communication or where the resources of the target cells dependant on the RNC 42 were saturated.

The symmetric operating scenario can be provided for the subscribers of the PLMN B. It can also be envisioned that the base stations 3 of the PLMN A in the strategic coverage area 31 are able to procure SHO links for them to complement those supplied by the shared base stations 2 in proximity to the strategic coverage area 31, in order to improve the transmission conditions.

Taking the PLMN identity into account in the handover procedure can also be useful in the cases where the home network of the terminal 1 does not correspond to either the PLMN A or the PLMN B, but to a third PLMN, for example a foreign PLMN in the case of “roaming”. The algorithm for the choice of the target cell made by the RNC 41 may favor the PLMN A on which the communication started, or else the PLMN B. It may also share the traffic between the two PLMNs A and B depending on multiple criteria which could be linked to the load of the cells of the first access network, or on any other parameter. In this respect, taking the PLMN identity into account offers the operators a wide flexibility as regards accepting the roaming agreements that suit them.

It will be clear that the invention is not limited to the embodiment described above by way of an example. It could equally be extended to other variants.

Among the latter, it could be mentioned that the two previously described access networks of the PLMNs A and B might be connected, for example, to the same MSC or else to completely different core networks.

Finally, other applications of the invention can be envisioned, such as that which consists in implementing the invention in a UMTS network for packet-mode data transmission. Yet another application of the invention relates, for example, to at least one access network which may have at least one core network and which is based on a different radiocommunications technology, for example of the GSM type (Global System for Mobile communications).

1. A method for controlling radio resources allocated to a mobile terminate in communication in a cellular system, in which radio measurements relating to propagation conditions between the terminal and a group of base stations of the cellular system are obtained, and said measurements are analyzed so as to select at least one base station and to establish a radio link between the terminal and the selected base station in order to ensure continuity of the communication, in which the cellular system comprises a first group of base stations procuring radio access resources for terminals of subscribers to a first network and a second group of base stations procuring radio access resources for terminals of subscribers to a second network, the first and second groups having a common sub-group of shared base stations, and in which, when the terminal in communication has an active radio link with a shared base station of said sub-group, a radio network controller of the cellular system stores information identifying a home network of said terminal and the selection of another base station not belonging to said sub-group is made in a manner depending on the stored information identifying the terminal home network, the selection of a base station of the second group outside of the sub-group of shared base stations being favored when the home network of the terminal identified by the stored information is the second network.

2. The method as claimed in claim 1, in which the information identifying the home network of the terminal forms part of a mobile subscriber identity supplied to said radio network controller.

3. The method as claimed in claim 1, in which the information identifying the home network of the terminal is supplied by a core network during the establishment of communication resources, in order to be available to said radio network controller.

4. (cancelled).

5. (cancelled).

6. The method as claimed in claim 1, in which the group of base stations, for which measurements are obtained, is exclusively composed of base stations of the first group of base stations if the home network of the terminal identified by the stored information is the first network and is exclusively composed of base stations from the second group of base stations if the home network of the terminal identified by the stored information is the second network.

7. The method as claimed in claim 1, in which measurements relating to said group of base stations are obtained, independently of whether these base stations belong to the first or second group, which the radio network controller sorts and takes into account with respect to favoring the selection of base stations from the first group of base stations if the home network of the terminal identified by the stored information is the first network and to favoring the selection of base stations from the second group of base stations if the, home network of the terminal identified by the stored information is the second network.

8. (cancelled).

9. A radio network control device designed to control radio resources allocated to a mobile terminal in communication in a cellular system, the radio network control device comprising means for obtaining radio measurements relating to propagation conditions between the terminal and a group of base stations of the cellular system, means for analyzing said measurements and means for selecting at least one base station and establishing a radio link between the terminal and the selected base station in order to ensure continuity of the communication, the cellular system comprising a first group of base stations procuring radio access resources for terminals of subscribers to a first network and a second group of base stations procuring radio access resources for terminals of subscribers to a second network, the first and second groups having a common sub-group of shared base stations, the radio network control device also comprising means for, when the terminal in communication has an active radio link with a shared base station of said sub-group, storing information identifying a home network of said terminal and in which the means for selecting at least one base station selects another base station not belonging to said sub-group in a manner depending on the stored information identifying the terminal home network, the selection of a base station of the second group outside of the sub-group of shared base stations being favored when the home network of the terminal identified by the stored information is the second network.

10. The radio network control device as claimed in claim 9, comprising means for obtaining a mobile subscriber identity and in which the information identifying the home network of the terminal forms part of said mobile subscriber identity.

11. The radio network control device as claimed in claim 9, comprising means for obtaining the information identifying the terminal home network from a core network during the establishment of communication resources.

12. The radio network control device as claimed in claim 9, in which said group of base stations, from which the means for obtaining radio measurements relating to propagation conditions between the terminal and a group of base stations of the cellular system are implemented, is exclusively composed of base stations of the first group of base stations if the home network of the terminal identified by the stored information is the first network and is exclusively composed of base stations from the second group of base stations if the home network of the terminal identified by the stored information is the second network.

13. The radio network control device as claimed in claim 9, in which means for obtaining radio measurements relating to propagation conditions between the terminal and a group of base stations of the cellular system are implemented independently of whether these base stations belong to the first or second group, the radio network control device also comprising means for sorting and taking into account said measurements with respect to favoring the selection of base stations from the first group of base stations if the home network of the terminal identified by the stored information is the first network and to favoring the selection of base stations from the second group of base stations if the home network of the terminal identified by the stored information is the second network.
